(19) United States
(12) Patent Application Publication
(10) Pub. No.: US 2008/0066574 A1
(43) Pub. Date: Mar. 20, 2008

(54) ACTUATOR

(75) Inventors: Itsuo MURATA, Kyoto (JP); Hiroshi YOKOI, Tokyo (JP); Makoto YAMASHITA, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku (JP)

(21) Appl. No.: 11/857,511

(22) Filed: Sep. 19, 2007

(30) Foreign Application Priority Data
Sep. 19, 2006 (JP) 2006-252672
Feb. 13, 2007 (JP) 2007-031460

(51) Int. Cl. B23Q 16/02

(52) U.S. Cl. 74/826

(57) ABSTRACT

A twisted string actuator as a light-weight and space saving actuator includes a small motor and a twisted string having a structure in which two strings are twisted with each other loosely. A first end of the twisted string is connected to a finger joint, and a second end of the same is connected to a rotation shaft of the motor via a power transmission mechanism. When the rotation shaft of the motor rotates, a twisted state of the two strings of the twisted string is tightened or loosened, so that a length of the twisted string is decreased or increased. As a result, the finger joint is driven to rotate about the axis.

### BACKGROUND OF THE INVENTION

1. Field of the Invention

The present invention relates to an actuator that can be used in a motorized artificial arm, a robot hand or the like. More specifically, the present invention relates to an actuator that utilizes a motor and a twisted string having a structure in which two strings are twisted with each other.

2. Description of the Related Art

Conventionally, there is an actuator utilizing wires (or strings) and a motor (hereinafter referred to as a wire actuator) as described in Japanese unexamined patent publications Nos. 6-8178 and 7-96485. Among various wire actuators utilizing a motor and wires or strings (hereinafter referred to as strings, simply) for finger joints, a structure having a concept that is related to the present invention is shown in FIG. 11 as a basic concept.

In FIG. 11, a rotating member 102 such as a pulley is connected to a rotation shaft 101a of a motor 101 via a reduction gear. Alternatively, the rotating member 102 is connected directly to the rotation shaft 101a of the motor 101 that includes the reduction gear. Two positions of the rotating member 102 that are opposed in its radial direction are connected to two strings 103 and 104, respectively. The other ends of the strings 103 and 104 are connected to a finger joint 105.

When the rotation shaft 101a of the motor 101 rotates, the rotating member 102 rotates slowly, and the two strings 103 and 104 are moved in opposite directions. In other words, one of the two strings 103 and 104 is pulled, while the other is released. As a result, the finger joint 105 is driven to rotate about an axis AX.

If the wire actuator described above is used in a motor artificial arm, a robot hand or the like having a lot of joints, one motor is necessary for each of the joints. In order to reduce the weight of the entire device, small motors or ultra-compact motors should be used. On the other hand, in order to secure a predetermined or more grasping force that is required to the motorized artificial arm, the robot hand or the like, a drive system including the motor and the reduction gear must be able to generate an output torque that is greater than a minimum torque necessary for it.

Although it is possible to obtain a large torque by a small motor with a reduction gear, the weight of the entire device will increase due to the weight of the reduction gear. As a result, there will be a problem that a distal end portion of the artificial arm (hand) becomes too heavy, for example. In addition, a space for embedding the reduction gear is necessary. Therefore, it is difficult to realize a small and light-weight motorized artificial arm or robot hand.

Furthermore, there is another problem that noise is generated due to engagement of teeth of gears if the reduction gear defined by a multistage gear is used, adding to the problems involving weight and space described above.

### SUMMARY OF THE INVENTION

A preferred embodiment of the present invention provides an actuator using a motor and a twisted string having a structure in which two strings are twisted with each other. A first end of the twisted string is connected to a drive target while a second end of the twisted string is connected to a rotation shaft of the motor directly or indirectly via a power transmission mechanism. When a rotation shaft of the motor rotates, a twisted state of the two strings is tightened or loosened in accordance with a rotation direction of the rotation shaft, so that a length of the twisted string is decreased or increased when the motor rotates. As a result, the drive target is driven.

According to this structure, the twisted string converts the rotational movement in the twisting direction thereof (i.e., torque) into linear movement in the length direction (i.e., tension), so it works as a power transmission mechanism including a reduction gear. Therefore, a reduction gear having a multistage gear or the like becomes unnecessary, which can contribute largely to significant reductions in the size and the weight of the entire device. In addition, noise is not generated unlike the reduction gear having a multistage gear or the like, so that a silent actuator can be realized. Furthermore, since the twisted string is generally inexpensive compared with a reduction gear having a multistage gear or the like, the cost of the actuator can be reduced.

In addition, since there is flexibility and resilience to some extent between the rotational movement in the twisting direction and the linear movement in the length direction of the twisted string, a so-called soft actuator can be realized without using an elastic member such as a spring or an air cylinder. Thus, a compliance function like that of a human hand has can be realized easily.

In addition, the actuator according to a preferred embodiment of the present invention may include a slide member that can slide along a slide guide within a predetermined range so as to restrict a driving direction and a driving range of the drive target. The first end of the twisted string is connected to the drive target via the slide member.

According to this structure, a driving direction and a driving range of the drive target can be restricted easily by the slide guide and the slide member. In addition, flexibility in design about a distance between the motor and the drive target as well as a direction between them can be secured, so it is easy to satisfy a restriction of space where the actuator is mounted and to utilize the space effectively.

Furthermore, the drive target may be a finger joint, and the actuator according to a preferred embodiment of the present invention may include two actuator kits each of which has the twisted string and the slide member, so that the finger joint is rotated about an axis.

According to this structure, the twisted strings of the two actuator kits are driven in opposite directions. More specifically, one of the twisted strings is driven in a shortening direction while the other twisted string is driven in the extending direction, so that the finger joint can be driven easily and accurately.

Other features, elements, advantages and characteristics of the present invention will become more apparent from the following detailed description of preferred embodiments thereof with reference to the attached drawings.

### BRIEF DESCRIPTION OF THE DRAWINGS

FIGS. 1A and 1B are schematic diagrams showing a concept of a twisted string actuator according to a preferred embodiment of the present invention.

FIG. 2 shows an example of driving a finger joint by using the twisted string actuator according to a preferred embodiment of the present invention.

FIG. 3 shows an example of an application of the twisted string actuator shown in FIG. 2 to a plurality of finger joints.

FIGS. 4A and 4B show an example in which single motor drives two twisted strings simultaneously.

FIG. 5 shows a state in which the twisted string actuator shown in FIG. 4A is driven to a limit of a driving range.

FIG. 6 is a schematic diagram of the twisted string actuator according to a first preferred embodiment of the present invention.

FIG. 7 is a schematic diagram of the twisted string actuator according to a second preferred embodiment of the present invention.

FIG. 8 is a cross sectional view of a motor and a gear box of the twisted string actuator according to a third preferred embodiment of the present invention.

FIG. 9 is a cross sectional view of a motor and a gear box of the twisted string actuator according to a fourth preferred embodiment of the present invention.

FIG. 10 is a cross sectional view of a motor of the twisted string actuator according to a fifth preferred embodiment of the present invention.

FIG. 11 is a schematic diagram showing a basic concept of an exemplary conventional wire actuator.

### DETAILED DESCRIPTION OF PREFERRED EMBODIMENTS

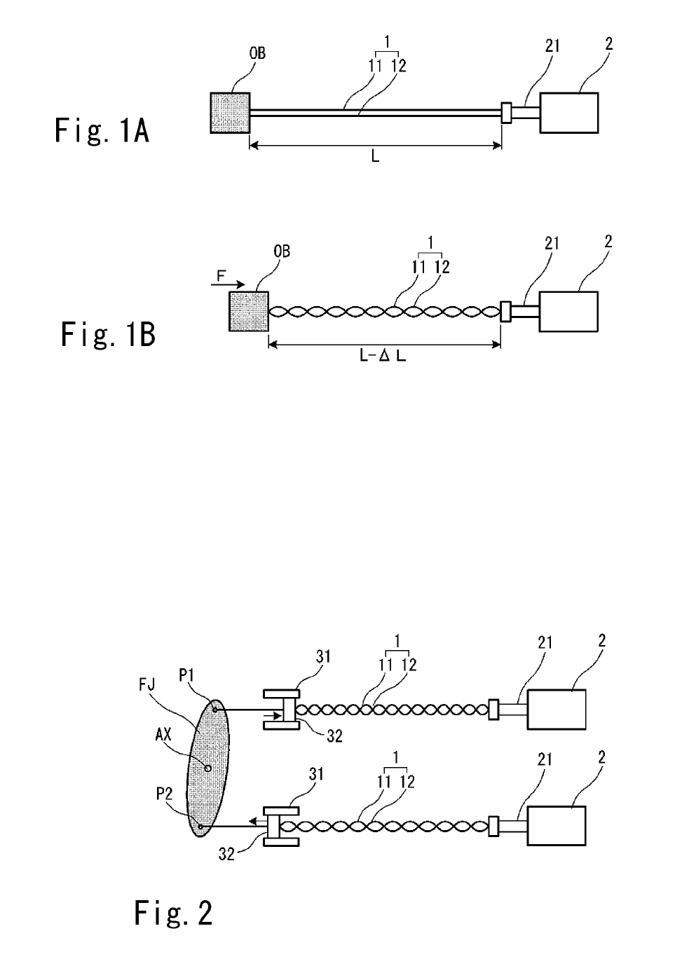

Hereinafter, preferred embodiments of the present invention will be described with reference to FIGS. 1A through 10. Note that relative positions and directions of members, which are described as upper, lower, left or right in the following description, are merely relative positions and directions in the drawings and do not mean actual relative positions and directions when they are installed in real equipment.

FIGS. 1A and 1B are schematic diagrams showing a concept of a twisted string actuator according to a preferred embodiment of the present invention. As shown in FIGS. 1A and 1B, the twisted string actuator according to the present invention preferably includes a motor 2 and a twisted string 1 that has a structure in which two strings or wires (hereinafter referred to as strings, simply) 11 and 12 are twisted loosely. FIG. 1A schematically shows the two strings 11 and 12 that are loosened to be two parallel strings, and FIG. 1B schematically shows the two strings 11 and 12 that are twisted with each other. An end (first end) of the twisted string 1 (i.e., two strings 11 and 12) is connected (fixed) to an object OB to be driven (hereinafter, it may also referred to as a drive target), and the other end (second end) thereof is connected (fixed) to a rotation shaft 21 of the motor 2.

The twisted string 1 in the state shown in FIG. 1A has a length L. From this state, the rotation shaft 21 of the motor 2 rotates so that the two strings 11 and 12 of the twisted string 1 are twisted with each other as shown in FIG. 1B. Then, the length of the twisted string 1 becomes L-ΔL. In other words, when the two strings 11 and 12 are twisted with each other, the length of the twisted string 1 is shortened by ΔL. As a result, the drive target OB is pulled by a driving force F due to tension of the twisted string 1 in the direction toward the motor 2 (toward the right side). Therefore, the twisted string 1 has a function of converting rotational movement in the twisting direction thereof (i.e., the torque of the motor 2) into linear movement in the length direction (i.e., the tension of the twisted string 1).

In addition, if the rotation shaft 21 of the motor 2 rotates reversely from the state shown in FIG. 1B, the two strings 11 and 12 of the twisted string 1 are loosened. If the object OB is pulled or pushed toward the left side by an appropriate force generated by a spring or the like though it is not shown in FIGS. 1A and 1B, the object OB will be moved by the force in the direction apart from the motor 2 (toward the left side), so that the length of the twisted string 1 increases. It is understood that the length of the twisted string 1 becomes a maximum value (L) when the two strings 11 and 12 are loosened to be two parallel strings as shown in FIG. 1A.

Therefore, according to the twisted string actuator of the present preferred embodiment including the motor 2 and the twisted string 1 having the structure in which two strings 11 and 12 are twisted with each other loosely, the twisted state of the two strings 11 and 12 of the twisted string 1 is tightened or loosened in accordance with a rotation direction of the rotation shaft 21 of the motor 2, so that the length of the twisted string 1 is decreased or increased. As a result, the drive target OB can be driven within a predetermined range.

Since the twisted string 1 works as a power transmission mechanism including a reduction gear, a reduction gear having a multistage gear or the like becomes unnecessary, which can contribute largely to reduction of size and weight of the entire device. In addition, noise is not generated unlike the reduction gear having a multistage gear or the like, so that a silent actuator can be realized. Furthermore, since the twisted string is generally inexpensive compared with a reduction gear having a multistage gear or the like, the cost of the actuator can be reduced.

In addition, since there is flexibility and resilience to some extent between the rotational movement in the twisting direction and the linear movement in the length direction of the twisted string 1, a so-called soft actuator can be realized without using an elastic member such as a spring or an air cylinder. Thus, a compliance function like that of a human hand can be realized easily.

FIG. 2 is a schematic diagram showing a preferred embodiment of the twisted string actuator according to the present invention. In this preferred embodiment and other preferred embodiments that will be described later, a finger joint FJ that can rotate about an axis AX corresponds to the drive target. As shown in FIG. 2, there is a slide member 32 that can move along a slide guide 31 within a predetermined range in order to restrict driving direction and driving range of the finger joint FJ as the drive target, and one end of the twisted string 11 is connected to the finger joint FJ via the slide member 32.

In addition, there are two actuator kits each of which includes the twisted string 1 and the slide member 32, and two positions P1 and P2 of the finger joint FJ opposed each other with the axis AX between them are connected to end portions of the twisted strings 1 of the two actuator kits via the slide members 32, respectively.

According to the structure of this preferred embodiment, the driving direction and the driving range of the finger joint FJ as the drive target can be restricted easily by the slide guide 31 and the slide member 32. In addition, flexibility in designing a device about a distance between the motor 2 and the finger joint FJ as well as a direction between them can be secured, so it is easy to satisfy a restriction of space where the actuator is mounted and to utilize the space effectively. Although the driving direction of the finger joint FJ substantially matches the direction along the rotation shaft 21 of the motor 2 in FIG. 2, it is possible to adopt a structure in which a pulley or the like is used for bending the flexible twisted string 1 so that both directions are different by 90 degrees. In addition, it is also possible to make a distance between the finger joint FJ and the motor 2 smaller or larger.

In addition, the twisted strings 1 of the two actuator kits are driven in the opposite directions to each other. For example, the upper twisted string 1 is driven in the shortening direction while the lower twisted string 1 is driven in the extending direction as shown in FIG. 2. Thus, the finger joint FJ can be driven easily and accurately. In the structure shown in FIG. 2, two motors 2 are used for driving the twisted strings 1 of the two actuator kits individually. In this structure, it is necessary to drive and control the two motors 2 in a synchronous manner. In addition, it is preferable to provide an interlock circuit for preventing a situation where only one of the two motors 2 rotates. In order to simplify such a control or a circuit, a single motor may be used for driving the twisted strings 1 of the two actuator kits simultaneously as described later in another embodiment.

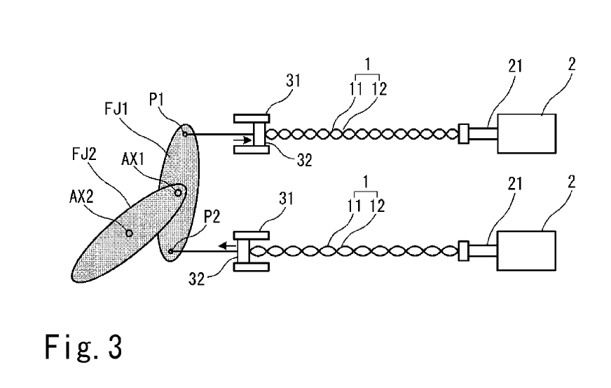

FIG. 3 is a schematic diagram showing and example of an application of the twisted string actuator shown in FIG. 2 to a plurality of finger joints, which illustrates a state where two finger joints FJ1 and FJ2 are connected to each other in a pivotable manner about an axis AX1. The finger joint FJ1 can rotate about the axis AX1, and the finger joint FJ2 can rotates about an axis AX2. Although it is omitted in FIG. 3, the finger joint FJ2 is also connected to a structure in the same manner as the finger joint FJ1, which includes two actuator kits each of which has the twisted string 1 and the slide member 32, and end portions of the twisted strings 1 of the two actuator kits are respectively connected to two positions that are opposed with the axis AX2 between them via the slide members 32. In this way, two twisted strings 1 are used for one joint. Therefore, 2n twisted strings 1 are used for n joints (n is a natural number).

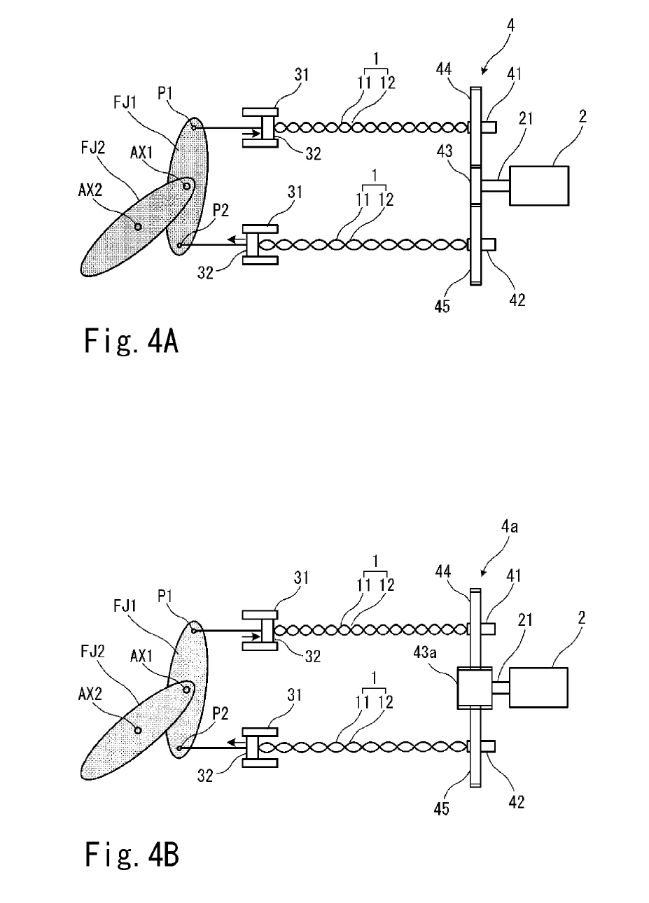

FIGS. 4A and 4B are schematic diagrams showing an example in which single motor drives two twisted strings simultaneously.

This preferred embodiment has a structure in which a single motor drives the twisted strings 1 of the two actuator kits simultaneously in the structure shown in FIG. 2 or 3. More specifically, the second ends (the ends close to the motor) of the twisted strings 1 of the two actuator kits are respectively connected to two output shafts 41 and 42 of a power transmission mechanism 4 that is connected to the rotation shaft 21 of the motor 2. When the rotation shaft 21 of the motor 2 rotates, the upper first output shaft 41 rotates in the direction of tightening the twisted state of the twisted string 1 connected thereto while the lower second output shaft 42 rotates in the direction of loosening the twisted state of the twisted string 1 connected thereto.

According to this structure, two actuator kits including the twisted string 1 each for the finger joint FJ1 while the motor 2 drives the two twisted string 1 simultaneously, driving control becomes more simple than the case where two motors drive them individually. In addition, a quick drive of the finger joint FJ1 can be realized.

In the structure shown in FIG. 4A, a reduction and reversal mechanism including three spur gears 43, 44 and 45 is preferably used as the power transmission mechanism 4. The center spur gear 43 is fixed to the rotation shaft 21 of the motor 2, the upper spur gear 44 is fixed to the first output shaft 41 to which the upper twisted string 1 is connected, and the lower spur gear 45 is fixed to the second output shaft 42 to which the lower twisted string 1 is connected. Since the upper spur gear 44 and the lower spur gear 45 rotate in the same direction (both in the direction opposite to the rotation direction of the center spur gear 43), it is necessary to set the twisting directions of the twisted strings 1 of the two actuator kits in opposite directions to each other.

In addition, FIG. 4B shows an example where the center spur gear 43 of the power transmission mechanism 4 shown in FIG. 4A is replaced with a pinion gear 43a. In this case too, the upper spur gear 44 and the lower spur gear 45 rotate in the same direction (both in the direction opposite to the rotation direction of the pinion gear 43a), so it is necessary to set the twisting directions of the twisted strings 1 of the two actuator kits in opposite directions to each other.

More specifically, when the rotation shaft 21 of the motor 2 rotates, the first output shaft 41 and the second output shaft 42 rotate in the same direction (both in the direction opposite to the rotation direction of the rotation shaft 21 of the motor 2). Since the twisting directions of the two twisted strings 1 are opposite to each other, the upper twisted string 1 is driven in the direction of tightening the twisted state (i.e., the direction of shortening its length) while the lower twisted string 1 is driven in the direction of loosening the twisted state (i.e., the direction of extending its length), for example, as shown in FIGS. 4A and 4B.

It is possible to change the number or a combination of gears of the power transmission mechanism 4, so that the rotation directions of the two output shafts 41 and 42 are opposite to each other direction in the power transmission mechanism 4. In this case, the twisting directions of the two twisted strings 1 should be the same direction. To sum up, it is sufficient to structure the power transmission mechanism 4 and the twisted strings 1 so that when the rotation shaft 21 of the motor rotates, one of the first output shaft 41 and the second output shaft 42 rotates in the direction of tightening the twisted state of the twisted string 1 while the other output shaft rotates in the direction of loosening the twisted state of the twisted string 1. However, it is preferable to structure the power transmission mechanism 4 so that output torque of the first output shaft 41 becomes the same as that of the second output shaft 42, or both torques are in valance.

In addition, it is possible to constitute the power transmission mechanism 4 by using a plurality of rollers or rollers and belts that transmit power with frictions between contacting surfaces instead of the gears in order to avoid generation of noise due to engagement of teeth of gears. Furthermore, it is preferable to use a brushless DC motor as the motor 2, so that noise generated from the motor 2 can be reduced.

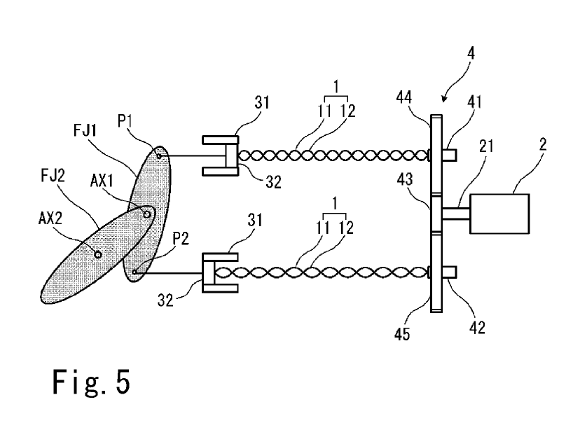

FIG. 5 is a schematic diagram showing a state in which the twisted string actuator shown in FIG. 4A is driven to a limit of a driving range. As described above, the driving range of this twisted string actuator (i.e., the driving range of finger joint FJ1) depends on a movable range of the slide member 32 that can slide along the slide guide 31.

In the state shown in FIG. 5, the slide member 32 connected to the upper twisted string 1 is moved to the right side limit in the movable range while the slide member 32 connected to the lower twisted string 1 is moved to the left side limit in the movable range. This state corresponds to the right rotation limit of the driving range of the finger joint FJ1 that can rotate about the axis AX1.

In this state, the upper twisted string 1 is in the state of minimum length (the most tightened state of the twisted state) in the driving range, while the lower twisted string 1 is in the state of maximum length (the most loosened state of the twisted state) in the driving range. In the left rotation limit of the driving range of the finger joint FJ1, they are in the relationship opposite to that described above. An initial twisted quantity of the twisted string 1 is decided so that a relationship between each rotation quantity of the output shaft 41 and 42 and each extended or contracted quantity of the upper and lower twisted strings 1 becomes linear as much as possible within the rotation driving range necessary for the finger joint FJ1.

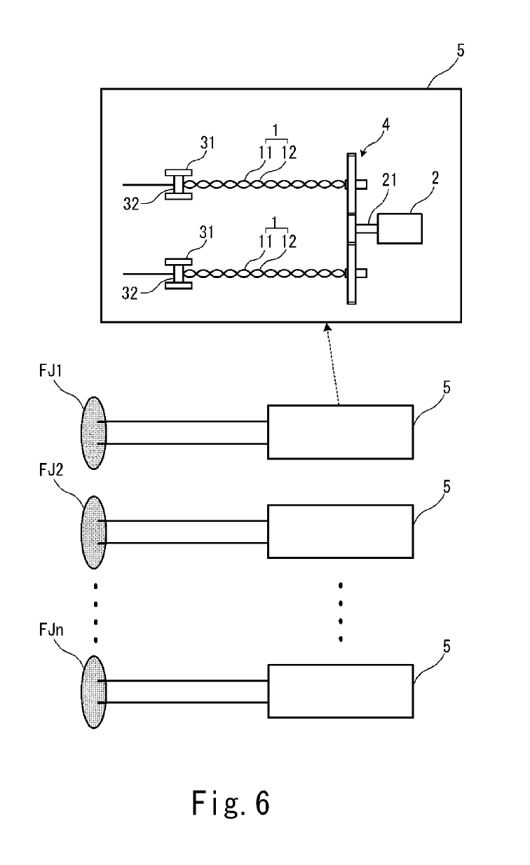

FIG. 6 is a schematic diagram showing a finger joint actuator for multiple joints according to a first preferred embodiment of the present invention. The finger joint actuator of this preferred embodiment includes n twisted string actuators 5 each of which includes the two actuator kits having the twisted string 1 and the slide member 32 as shown in FIG. 5, the motor 2 and the power transmission mechanism 4, and is connected to each of the finger joint FJ1, FJ2, . . . FJn as shown in FIG. 6. Since the number n of twisted string actuators 5 is used for the number n of finger joints to be driven, each of the finger joints can be driven individually by driving and controlling the motor 2 of each twisted string actuator 5.

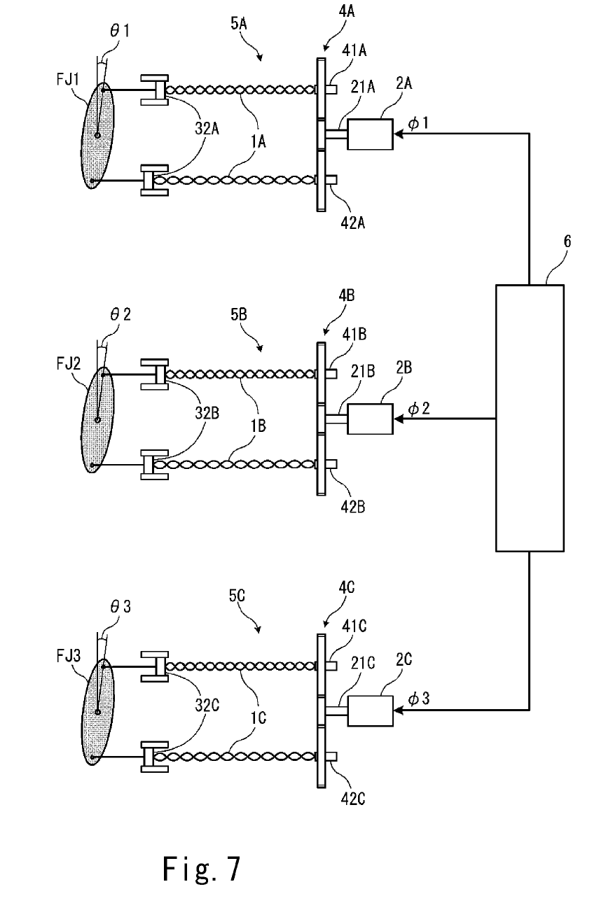

FIG. 7 is a schematic diagram showing the twisted string actuator according to a second preferred embodiment of the present invention. The finger joint actuator of this preferred embodiment uses three twisted string actuators so as to drive three finger joints that constitute one finger. As shown in FIG. 7, three twisted string actuators 5A, 5B and 5C are provided for driving the finger joints FJ1, FJ2 and FJ3 individually, and motors 2A, 2B and 2C of the twisted string actuators are driven and controlled by a controller 6. The controller 6 preferably includes a microcomputer, for example.

The controller 6 calculates target extended or contracted quantities ALA, ALB and ALC of twisted strings 1A, 1B and 1C connected to finger joints FJ1, FJ2 and FJ3 via slide members 32A, 32B and 32C in accordance with target angles θ1, θ2 and θ3 of the finger joints FJ1, FJ2 and FJ3 (target driving angles). Further the controller 6 calculates target rotation angles p1, p2 and p3 of rotation shafts 21A, 21B and 21C of the motors 2A, 2B and 2C connected to the corresponding twisted strings via power transmission mechanisms 4A, 4B and 4C in accordance with the calculated target extended or contracted quantities ALA, ALB and ALC of the twisted strings 1A, 1B and 1C. Then, it delivers driving signals corresponding to the target rotation angles to the motors 2A, 2B and 2C, respectively.

When the rotation shafts 21A, 21B and 21C of the motors 2A, 2B and 2C rotate by the target rotation angles p1, p2 and p3 responding to the corresponding driving signals, a pair of output shafts 41A and 42A, 41B and 42B, and 41C and 42C of the power transmission mechanisms 4A, 4B and 4C rotate. Then, the twisted strings 1A, 1B and 1C of the twisted string actuators 5A, 5B and 5C are extended or contracted by the target extended or contracted quantities ALA, ALB and ALC. As a result, pairs of slide members 32A, 32B and 32C of each of the twisted string actuators 5A, 5B and 5C are moved in the opposite directions by the target displacement quantity. Thus, the finger joints FJ1, FJ2 and FJ3 are driven to turn by the target driving angles θ1, θ2 and θ3.

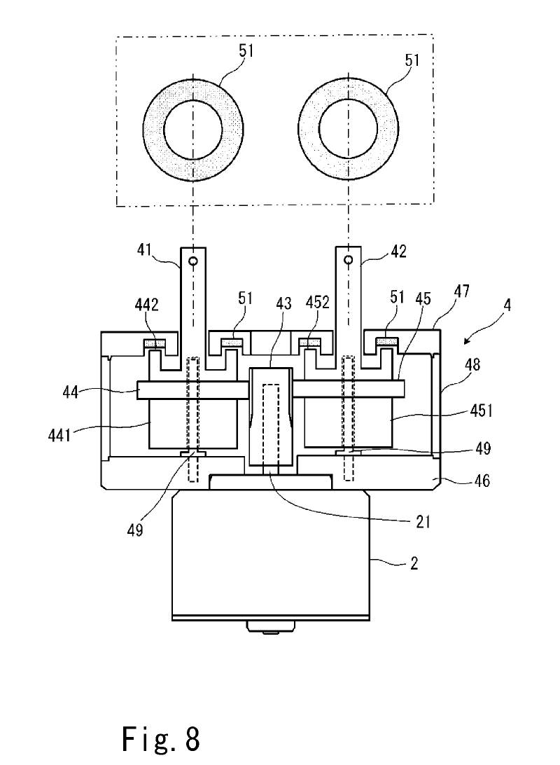

Next, FIG. 8 is a cross sectional view showing a structure of a motor and a gear box of an actuator according to a third preferred embodiment of the present invention. In this preferred embodiment, the motor 2 is combined integrally with the gear box corresponding to the power transmission mechanism 4a shown in FIG. 4B. The gear box 4a preferably has a box-like shape made up of a proximal end plate 46, a distal end plate 47 and side wall plates 48, so that the pinion gear 43a, the spur gears 44 and 45, and the like described above are disposed in its inner space.

The proximal end plate 46 of the gear box 4a has a center through hole at the middle portion for the rotation shaft 21 of the motor 2 and the pinion gear 43a fixed to the rotation shaft 21 to pass through, and a step-like recess for receiving a distal end portion of a case of the motor 2 is formed on the outer surface (lower surface) of the proximal end plate 46 around the center through hole. The step-like recess of the proximal end plate 46 and the distal end portion of the case of the motor 2 are fixed to each other by a force-fit, adhesive and/or screws, or other suitable connecting mechanisms.

In addition, two fixed shaft members 49 arranged to support the spur gears 44 and 45 are fixed to the inner surface (upper surface) of the proximal end plate 46 at both sides of the center through hole with a predetermined distance from the same. Cylindrical portions 441 and 451 are provided at upper and lower sides of each of the spur gears 44 and 45 integrally, and a sleeve bearing that surrounds the fixed shaft member 49 is provided at the middle portion thereof. Thus, the spur gears 44 and 45 can be retained by the fixed shaft member 49 and can rotate freely. Furthermore, the spur gears 44 and 45 engage with the pinion gear 43a so as to be driven to rotate when the rotation shaft 21 of the motor 2 rotates.

Output shafts 41 and 42 are integrally connected respectively to the spur gears 44 and 45 so as to protrude from the upper middle portion upward (toward distal end side), and the distal end plate 47 of the gear box 4a has two through holes for the output shafts 41 and 42 to pass through. Note that the output shaft 41 (42), the cylindrical portion 441 (451) and the spur gear 44 (45) may be formed separately and then combined integrally, or all or two of them may be formed as a single member.

Furthermore, ring-shaped grooves are formed on the inner surface (lower surface) of the distal end plate 47 around the through hole for the output shafts 41 and 42 to pass through, and a ring-shaped member 51 made of an oil-impregnated sintered alloy is embedded in each of the grooves and fixed with adhesive or the like. In addition, ring-shaped sliding surfaces 442 and 452 that can contact and slide with the ring-shaped members 51 are provided at the distal end sides of the cylindrical portions 441 and 451 (corresponding to driving portion rotor members). Note that a part encircled by a dashed and two-doted line in FIG. 8 at the upper portion shows a plan view of the ring-shaped members 51 viewed in the axis direction.

The ring-shaped member 51 has a function of a thrust bearing that retains the output shafts (drive rotation shafts) 41 and 42 thereby restricting movements thereof in the axial direction. More specifically, when a twisted state of the twisted string connected to the distal end of the output shaft 41 or 42 is tightened so that a length of the twisted string is decreased, there is an increasing force that pulls the output shafts 41 or 42 toward the drive target (hereinafter referred to as a thrust force) as a reaction of the driving force that pulls the drive target. This thrust force is received by the ring-shaped member 51 that contacts with the ring-shaped sliding surface 442 or 452 at the distal end of the cylindrical portion 441 or 451 that is the driving portion rotor member.

Since the ring-shaped member 51 is made of the oil-impregnated sintered alloy and secures smooth sliding with the ring-shaped sliding surface 442 or 452, rotation drive output is hardly decreased even if the thrust force increases. In addition, a space saving and inexpensive thrust bearing compared with a ball bearing can be realized. As a result, a compact and inexpensive twisted string actuator can be realized.

According to the actuator of this preferred embodiment, it is possible to provide a light-weight, space saving, low noise and inexpensive actuator using a small motor, in which rotation drive output is hardly decreased even if a pulling force in the thrust direction increases.

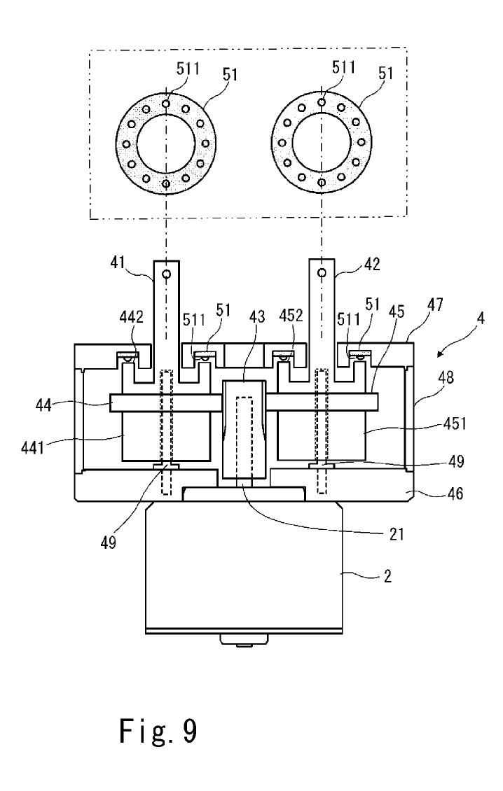

Next, FIG. 9 is a cross sectional view showing a structure of a motor and a gear box of an actuator according to a fourth preferred embodiment of the present invention. A structure of the actuator of this preferred embodiment is preferably the same as the structure of the actuator of the third preferred embodiment described above except for some differences. Therefore, the same elements are denoted by the same reference signs, and differences between this preferred embodiment and the third preferred embodiment will be described mainly.

In the third preferred embodiment, a contacting surface of the ring-shaped member 51 that contacts with the ring-shaped sliding surface 442 or 452 of the rotor side so as to constitute the thrust bearing is a flat surface, so both surfaces contact and slide with each other. In contrast, this preferred embodiment has a structure in which three or more (for example, twelve in this illustrated example) hemispheroid protrusions 511 are arranged with spaces in the circumferential direction on the ring-shaped surface of the ring-shaped member 51 that faces the ring-shaped sliding surface 442 or 452 of the rotor side as shown in FIG. 9, so that tip portions of the hemispheroid protrusions 511 contact with the ring-shaped sliding surface 442 or 452. In addition, the thrust bearing is constituted by point contacts of three or more points instead of surface contact.

According to the structure of this preferred embodiment, an area of the contacting surface (sliding surface) is smaller so that an output loss due to sliding friction between contacting surfaces can be reduced compared with the case where the thrust bearing is constituted by surface contact as described in the first preferred embodiment. Thus, it is possible to realize an inexpensive actuator, in which rotation drive output is hardly decreased even if the thrust force increases.

It is possible to modify the third or the fourth preferred embodiment so as to decrease a size in the axial direction (thickness) of the ring-shaped member 51 of the thrust bearing and to increase its inner diameter so that the inner surface thereof can contact with the output shaft 41 or 42. In this case, the ring-shaped member 51 can work as a radial bearing for retaining the output shafts 41 and 42 in the radial direction as well as the thrust bearing described above.

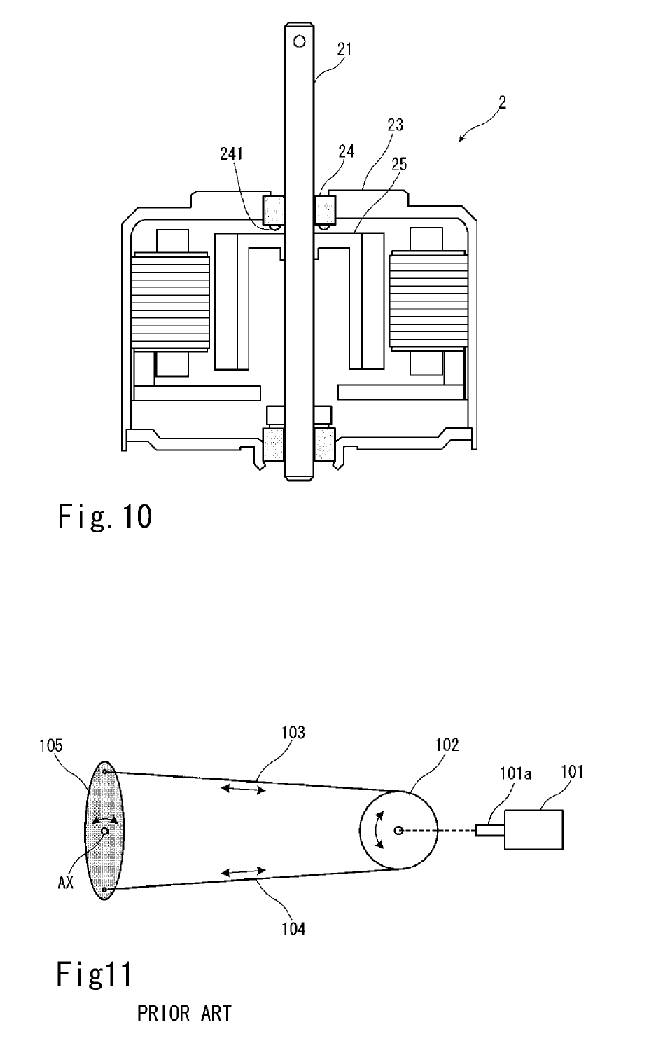

In addition, although the twisted string preferably is connected to the output shaft of the gear box 4a of the power transmission mechanism as the actuator shown in FIG. 4B in the third and the fourth preferred embodiments, it is possible to adopt a structure of the actuator shown in FIG. 3, in which the twisted string 1 is connected directly to the rotation shaft 21 of the motor 2. An example of this structure is shown in FIG. 10.

In FIG. 10, a sleeve 24 made of an oil-impregnated sintered alloy is disposed at the middle portion of the distal end side 23 of a case of the motor 2, and it works as a radial bearing for the rotation shaft 21 as well as a thrust bearing that can contact and slide with a distal end side (upper surface) of a rotor 25. In the illustrated example, three or more hemispheroid protrusions 241 are arranged with spaces in the circumferential direction on the ring-shaped surface of the sleeve 24 that faces the rotor 25 similarly to the thrust bearing of the second preferred embodiment, and tip portions of the hemispheroid protrusions 241 contact with the upper surface (ring-shaped sliding surface) of the rotor 25. It is preferable to apply a lubricant or the like between the hemispheroid protrusions 241 and the upper surface of the rotor 25 in order to reduce further the sliding friction between them.

The actuator according to various preferred embodiments of the present invention described above can be applied not only to finger joints of a motorized artificial arm, a robot hand and the like, but also to a wrist joint or other various joints. In addition, the actuator according to various preferred embodiments of the present invention can also be used as an actuator for an object that moves in a reciprocating manner without being limited to a rotational movement of the joint.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. An actuator for exerting driving force to a drive target, comprising:
a motor; and
a twisted string including two strings twisted with each other; wherein
a first end of the twisted string is connected to the drive target and a second end of the twisted string is connected to a rotation shaft of the motor; and
a twisted state of the two strings is tightened or loosened in accordance with a rotation direction of the rotation shaft to decrease or increase a length of the twisted string.

2. The actuator according to claim 1, further comprising a slide member slidable along a slide guide within a predetermined range to restrict a driving direction and a driving range of the drive target, wherein the first end of the twisted string is connected to the drive target via the slide member.

3. The actuator according to claim 1, wherein the second end of the twisted string is connected to the rotation shaft of the motor directly or indirectly via a power transmission mechanism.

4. The actuator according to claim 1, wherein the drive target is forced in the direction of extending the length of the twisted string at least when the twisted state of the two strings is loosened.

5. The actuator according to claim 2, wherein the drive target is a finger joint rotatable about an axis, and the actuator includes two actuator kits each of which has the twisted string and the slide member, and the first ends of the twisted strings of the two actuator kits are respectively connected via the slide members to two positions of the finger joint that are opposed to each other with the axis between them.

6. The actuator according to claim 5, wherein two motors are provided for the two actuator kits, and the second ends of the twisted strings of the two actuator kits are connected to the rotation shafts of the two motors, respectively.

7. The actuator according to claim 5, wherein a single motor is provided for the two actuator kits, and a rotation shaft of the motor is connected to a power transmission mechanism having two output shafts that are rotated simultaneously when the rotation shaft rotates, the second ends of the twisted strings of the two actuator kits are connected to the two output shafts of the power transmission mechanism, respectively, and when the rotation shaft of the motor rotates, one of the two output shafts rotates in the direction tightening the twisted state of the twisted string connected thereto while the other output shaft rotates in the direction loosening the twisted state of the twisted string connected thereto.

8. The actuator according to claim 7, wherein the two output shafts of the power transmission mechanism are arranged in parallel with each other, and the twisted strings of the two actuator kits that are connected to the two output shafts are arranged substantially in parallel with each other.

9. The actuator according to claim 7, wherein the power transmission mechanism has a reduction gear that reduces rotation speed and transmits power from the rotation shaft of the motor to the two output shafts.

10. The actuator according to claim 9, wherein the rotation shaft of the motor is provided with a small gear arranged in a concentric manner and the two output shafts are provided with large gears engaging with the small gear, the small gear and the large gears constituting the reduction gear.

11. The actuator according to claim 7, wherein the motor is a brushless DC motor.

12. The actuator according to claim 7, wherein the motor has a motor case from which the rotation shaft of the motor protrudes, a surface of the motor case from which the rotation shaft protrudes is provided with a box that encloses a protruding portion of the rotation shaft, and in the box, two output shafts are supported and connected to the rotation shaft so as to rotate in each direction by the rotation shaft, so that distal ends of the two output shafts protrude from the box and are connected to the two twisted strings, respectively.

13. The actuator according to claim 12, wherein the output shaft is provided with a ring-shaped thrust surface, and an inner surface of the box that faces the thrust surface is provided with a thrust bearing that is arranged to receive thrust force from the thrust surface that is exerted on the output shaft in its axis direction.

14. The actuator according to claim 13, wherein the thrust bearing is made of an oil-impregnated sintered alloy.

15. The actuator according to claim 14, wherein at least three hemispheroid protrusions are provided at the thrust bearing and spaced from each other in a circumferential direction thereof, and the thrust surface of the output shaft contacts the protrusions of the thrust bearing.

16. The actuator according to claim 1, further comprising a ring-shaped member retaining the drive rotation shaft and arranged to restrict its axial movement, wherein the ring-shaped member is made of an oil-impregnated sintered alloy, is disposed in a coaxial manner with the drive rotation shaft and fixed to a driving portion fixed side, a ring-shaped sliding surface that is in contact with and slidable on the ring-shaped member is provided at a driving portion rotor member fixed to the drive rotation shaft.

17. The actuator according to claim 16, wherein at least three hemispheroid protrusions are provided at one of ring-shaped surfaces of the ring-shaped member and spaced from each other in the circumferential direction, the surface facing the driving portion rotor member, tip portions of the hemispheroid protrusions being in contact with and slidable on the ring-shaped sliding surface of the driving portion rotor member.

18. The actuator according to claim 16, comprising
a motor;
two output shafts as the drive rotation shaft of a power transmission mechanism connected to a rotation shaft of the motor; and
two twisted strings that are connected to the two drive rotation shafts such that one of the two twisted strings is shortened and the other twisted string is extend in their lengths when the rotation shaft of the motor rotates; wherein
each of the two drive rotation shafts is provided with a thrust bearing including the ring-shaped member.
